(19) United States
(12) Patent Application Publication
(10) Pub. No.: US 2024/0195699 A1
(43) Pub. Date: Jun. 13, 2024

(54) CONSTRAINT AWARE FLOW BASED APPLICATION DISCOVERY - IMPROVED MACHINE LEARNING ALGORITHM FOR APPLICATION DISCOVERY

(71) Applicant: VMWARE, INC., Palo Alto, CA (US)

(72) Inventors: Madan Singhal, Pune (IN); Shubhrajyoti Mohapatra, Baripada (IN); Abhishek Shingane, Mumbai (IN)

(21) Appl. No.: 18/105,898

(22) Filed: Feb. 6, 2023

(30) Foreign Application Priority Data
Dec. 13, 2022 (IN) 202241071949

(51) Int. Cl. H04L 41/122; H04L 41/16; H04L 43/062

(52) U.S. Cl. CPC H04L 41/122; H04L 41/16; H04L 43/062

(57) ABSTRACT

A feature selection methodology is disclosed. In a computer-implemented method, components of a computing environment are automatically monitored, and have a feature selection analysis performed thereon. Provided the feature selection analysis determines that features of the components are well defined, a clustering of the features is performed. A constraint based semi supervised process is performed. Provided the feature selection analysis determines that features of the components are well defined, a similarity analysis of the sub-features of the feature is performed. Results of the feature selection methodology are generated.

### RELATED APPLICATIONS

Benefit is claimed under 35 U.S.C. 119(a)-(d) to Foreign Application Serial No. 202241071949 filed in India entitled “CONSTRAINT AWARE FLOW BASED APPLICATION DISCOVERY—IMPROVED MACHINE LEARNING ALGORITHM FOR APPLICATION DISCOVERY”, on Dec. 13, 2022, by VMware, Inc., which is herein incorporated in its entirety by reference for all purposes.

### BACKGROUND ART

Distributed computing platforms, such as in networking products (NP) provided by VMware, Inc., of Palo Alto, California (VMware) include software that allocates computing tasks across group or cluster of distributed software components executed by a plurality of computing devices, enabling large data sets to be processed more quickly than is generally feasible with a single software instance or a single device. Such platforms typically utilize a distributed file system that can support input/output intensive distributed software component running on a large quantity (e.g., thousands) of computing devices to access large quantity of data. For example, the NP distributed file system (HDFS) is typically used in conjunction with NP—a data set to be analyzed by NP may be stored in as a large file on HDFS which enables various computing devices running NP software to simultaneously process different portions of the file.

Typically, distributed computing platforms such as NP are configured and provisioned in a “native” environment, where each “node” of the cluster corresponds to a physical computing device. In such native environment, where each “node” of the cluster corresponds to a physical computing device. In such native environments, administrators typically need to manually configure the settings for the distributed computing platform by generating and editing configuration or metadata files that, for example, specify the names and network addresses of the nodes in the cluster, as well as whether any such nodes perform specific functions for the distributed computing platform. More recently, service providers that offer cloud-based Infrastructure-as-a-Service (LaaS) offerings have begun to provide customers with NP frameworks as a “Platform-as-a-Service” (PaaS).

Such PaaS based NP frameworks however are limited, for example, in their configuration flexibility, reliability and robustness, scalability, quality of service (QoS) and security. These platforms also have the further problem of being able to handle disparate computing endpoints with huge volume of application is a very efficient discoverable manner.

Accurate and comprehensive application awareness (boundary, components, dependencies) is a pre-requisite for effectively driving many datacenter operations workflows, including micro-segmentation security planning network troubleshooting, applications performance optimization, application migration.

Manual classification of endpoints (e.g., virtual machines) to applications and tiers is a cumbersome and error-prone process and its quality depends on many factors including proper assignment of attributes (name, tag, etc.) to an endpoint. Besides, to validate such classification, one needs to analyze the network communication pattern among these groups. Also, with the regular influx of new endpoints in the data center, the classification needs to be continually updated. This process is not practical for an environment with thousands of applications.

Automated and continuous discovery of applications (and tiers) addresses these concerns as it requires fewer manual efforts and can dynamically adapt.

The complexity of application discovery increases with the diversity of applications that can exist in a data center. A data center can comprise of simple as well as relatively complex applications that co-exist and interact with each other. The existence of common services like AD, DNS, etc., complicates the task of identifying application boundaries. FIG. 1 is an example of a topology with applications and common services. In FIG. 1, each circle represents a virtual or physical endpoint. Different applications and common services groups have been grouped differently to demarcate them properly. As can be seen from the topology shown in FIG. 1, it appears very difficult to track, monitor and trace where applications exist and what their boundaries are.

Current conventional discoveries to automated discovery suffer from the following drawbacks: (a) any agent-based solution that requires the installation of agents at the hypervisor or operating system level is quite intrusive in nature and can pose security challenges, (b) some of the agentless solutions require pervasive access to all servers in order to execute appropriate commands to collect information related to processes, connections, etc. This is not ideal from a security or performance perspective.

It should also be noted that most computing environments, including virtual network environments are not static. That is, various machines or components are constantly being added to, or removed from, the computer environment. As such changes are made to the computing environment, it is frequently necessary to amend or change which of the various machines or components (virtual and/or physical) are registered with the security system. And even in a perfectly laid out network environment the introduction of components and machines is bound to introduce segmentations and hairpins which affect the performance of the network. These performance problems are more exacerbated in the virtual computing environment with heavy network traffic between them.

In conventional approaches to discovery and monitoring of services and applications in a computing environment, constant and difficult upgrading of agents is often required. Thus, conventional approaches for application and service discovery and monitoring are not acceptable in complex and frequently revised computing environments.

Additionally, many conventional security systems require every machine or component within a computing environment be assigned to a particular scope and service group so that the intended states can be derived from the service type. As the size and complexity of computing environments increases, such a requirement may require a high-level system administrator to manually register as many as thousands (or many more) of the machines or components (such as, for example, virtual machines) with the security system.

Thus, such conventionally mandated registration of the machines or components is not a trivial job. This burden of manual registration is made even more burdensome considering that the target users of many security systems are often experienced or very high-level personnel such as, for example, Chief Information Security Officers (CISOs) and their teams who already have heavy demands on their time.

Furthermore, even such high-level personnel may not have full knowledge of the network topology of the computing environment or understanding of the functionality of every machine or component within the computing environment. Hence, even when possible, the time and/or person-hours necessary to perform and complete such a conventionally required configuration for a computing system can extend to days, weeks, months or even longer.

Moreover, even when such conventionally required manual registration of the various machines or components is completed, it is not uncommon that entities, including the aforementioned very high-level personnel, have failed to properly assign the proper scopes and services to the various machines or components of the computing environment. Furthermore, in conventional computing systems, it not uncommon to find such improper assignment of scopes and services to the various machines or components of the computing environment even after a conventional computing system has been operational for years since its initial deployment. As a result, such improper assignment of the scopes and services to the various machines or components of the computing environment may have significantly and deleteriously impacted the accessibility by applications and the overall performance of conventional computing systems even for a prolonged duration.

Furthermore, as stated above, most computing environments, including machine learning environments are not static. That is, various machines or components are constantly being added to, or removed from, the computing environment. As such changes are made to the computing environment, it is necessary to review the changed computing environment and once again assign the proper scopes and services to the various machines or components of the newly changed computing environment. Hence, the aforementioned overhead associated with the assignment of scopes and services to the various machines or components of the computing environment will not only occur at the initial phase when deploying a conventional security system, but such aforementioned overhead may also occur each time the computing environment is expanded, updated, or otherwise altered. This includes instances in which the computing environment is altered, for example, by expanding, updating, or otherwise altering, for example, the roles of machine or components including, but not limited to, virtual machines of the computing environment.

Thus, conventional approaches for providing application discovery in a distributed computing platform with a large number of disparate components and applications of a computing environment, including a machine learning environment, are highly dependent upon the skill and knowledge of a system administrator. Also, conventional approaches for providing learning to machines or components of a computing environment, are not acceptable in complex and frequently revised computing environments

### BRIEF DESCRIPTION OF THE DRAWINGS

The accompanying drawings, which are incorporated in and form a part of this specification, illustrate embodiments of the present technology and, together with the description, serve to explain the principles of the present technology.

FIG. 1 shows an example of a conventional data center application topology with common services;

FIG. 2 shows an example computer system upon which embodiments of the present invention can be implemented, in accordance with an embodiment of the present invention

FIG. 3 is a block diagram of an exemplary virtual computing network environment, in accordance with an embodiment of the present invention

FIG. 4A is a high-level block diagram showing an example of workflow approach of one embodiment of the present invention.

FIG. 4B is a high-level block diagram of a software-defined network in accordance with one embodiment of the present invention.

FIG. 5 is a block diagram showing an example of different functions of the machine learning based application discovery method of one embodiment, in accordance with an embodiment of the present invention.

FIG. 6 is a flow diagram of one embodiment of the application discovery method, in accordance with an embodiment of the present invention.

FIG. 7 is a topology diagram of an example of an application cluster detected in applying the application discovery method, in accordance with an embodiment of the present invention.

FIG. 8 is a topology diagram of an exemplary multi-tiered application discovery for a virtual computing network environment, in accordance with an embodiment of the present invention.

FIG. 9 is a diagram of Application 1 and Application 2, with multiple VMs belonging to each application.

FIG. 10 is a graph outlining the constraints assigned to an example set of VMs.

FIG. 11 is a diagram of boosting based semi supervised iterative clustering algorithm.

FIG. 12 is a diagram of clustering using a super node approach.

FIG. 13 is a table of the vector space and the reduced vector space with the threshold set to 0%.

FIG. 14 is a table of the vector space and the reduced vector space with the threshold set to 100%.

FIG. 15 is an example setup of Application 1, Application 2, and their respective VMs.

FIG. 16 is an example of a table of inputs and a table of outputs for a fast embed approach.

FIG. 17 is an example table of an original embedding matrix.

FIG. 18 is an example table of a sub matrix.

FIG. 19 is an example of an altered sub matrix.

FIG. 20 is an example table of a final embedding matrix.

FIG. 21 shows a diagram of a constraint aware Flow Based Application Discovery pipeline

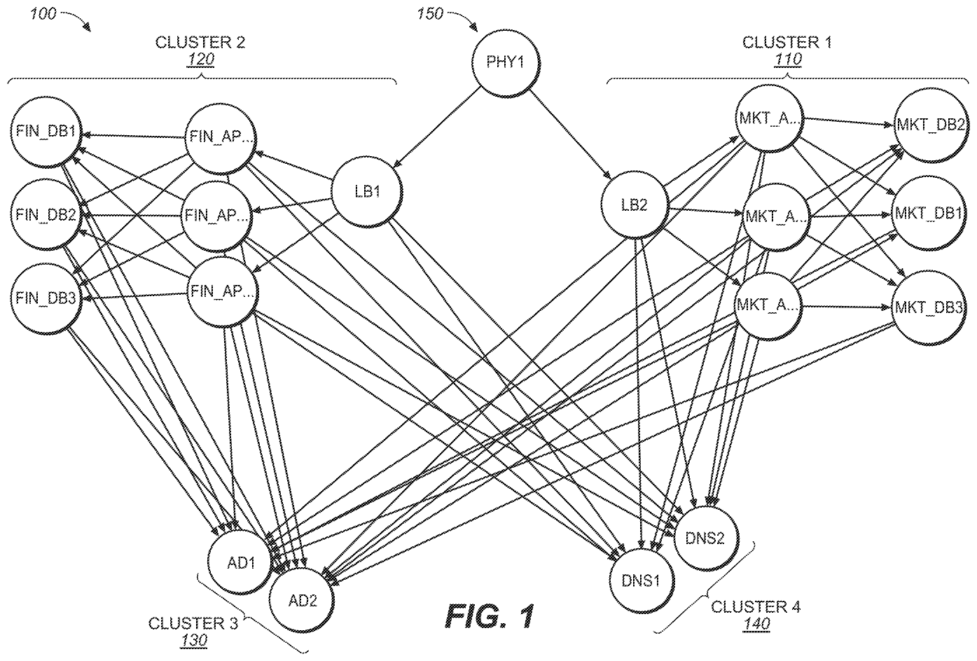

The drawings referred to in this description should not be understood as being drawn to scale except if specifically noted.

### DETAILED DESCRIPTION OF EMBODIMENTS

Reference will now be made in detail to various embodiments of the present technology, examples of which are illustrated in the accompanying drawings. While the present technology will be described in conjunction with these embodiments, it will be understood that they are not intended to limit the present technology to these embodiments. On the contrary, the present technology is intended to cover alternatives, modifications and equivalents, which may be included within the spirit and scope of the present technology as defined by the appended claims. Furthermore, in the following description of the present technology, numerous specific details are set forth in order to provide a thorough understanding of the present technology. In other instances, well-known methods, procedures, components, and circuits have not been described in detail as not to unnecessarily obscure aspects of the present technology.

### Notation and Nomenclature

Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be one or more self-consistent procedures or instructions leading to a desired result. The procedures are those requiring physical manipulations of physical quantities. Usually, although not necessarily, these quantities take the form of electrical or magnetic signals capable of being stored, transferred, combined, compared, and otherwise manipulated in an electronic device.

It should be borne in mind, however, that all of these and similar terms are to be associated with the appropriate physical quantities and are merely convenient labels applied to these quantities. Unless specifically stated otherwise as apparent from the following discussions, it is appreciated that throughout the description of embodiments, discussions utilizing terms such as “displaying”, “identifying”, “generating”, “deriving”, “providing,” “utilizing”, “determining,” or the like, refer to the actions and processes of an electronic computing device or system such as: a host processor, a processor, a memory, a virtual storage area network (VSAN), virtual local area networks (VLANS), a virtualization management server or a virtual machine (VM), among others, of a virtualization infrastructure or a computer system of a distributed computing system, or the like, or a combination thereof. The electronic device manipulates and transforms data, represented as physical (electronic and/or magnetic) quantities within the electronic device's registers and memories, into other data similarly represented as physical quantities within the electronic device's memories or registers or other such information storage, transmission, processing, or display components.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the Figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example mobile electronic device described herein may include components other than those shown, including well-known components.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, perform one or more of the methods described herein. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits and instructions described in connection with the embodiments disclosed herein may be executed by one or more processors, such as one or more motion processing units (MPUs), sensor processing units (SPUs), host processor(s) or core(s) thereof, digital signal processors (DSPs), general purpose microprocessors, application specific integrated circuits (ASICs), application specific instruction set processors (ASIPs), field programmable gate arrays (FPGAs), or other equivalent integrated or discrete logic circuitry. The term “processor,” as used herein may refer to any of the foregoing structures or any other structure suitable for implementation of the techniques described herein. In addition, in some embodiments, the functionality described herein may be provided within dedicated software modules or hardware modules configured as described herein. Also, the techniques could be fully implemented in one or more circuits or logic elements. A general-purpose processor may be a microprocessor, but in the alternative, the processor may be any conventional processor, controller, microcontroller, or state machine. A processor may also be implemented as a combination of computing devices, e.g., a combination of an SPU/MPU and a microprocessor, a plurality of microprocessors, one or more microprocessors in conjunction with an SPU core, MPU core, or any other such configuration.

The following terms will be frequently used throughout the application
(a) Tier: A tier is a collection of endpoints based on a certain role (e.g., a tier comprising of database endpoints.
(b) Application: An application is a collection of tiers, e.g., a simple application comprising web, app and database tiers;
(c) Hosted Port: It is a port exposed by an endpoint by the virtue of hosting a service, e.g., port 443 exposed by endpoints of web tier;
(d) Accessed Port: It is the port accessed by an endpoint consuming a service hosted on a server in the datacenter. e.g., port 389 accessed by endpoints consuming LDAP services;
(e) Communication Profile: Communication profile of an endpoint is the snapshot of incoming and outgoing connections (including endpoints at other ends) with respect to the endpoint; and
(f) Communication Density: For a group of endpoints, the communication density is directly proportional to the degree of connectivity among the nodes of the group.

### Example Computer System Environment

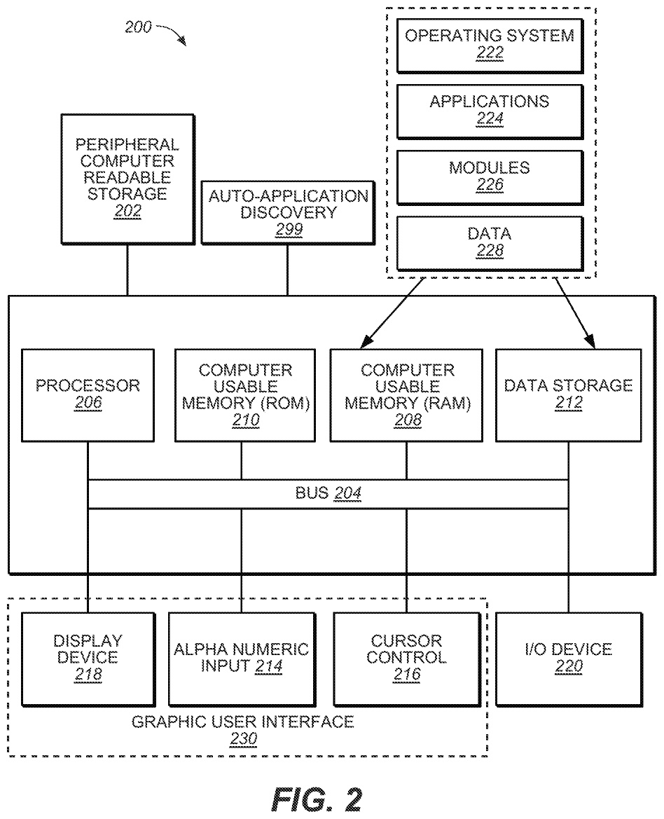

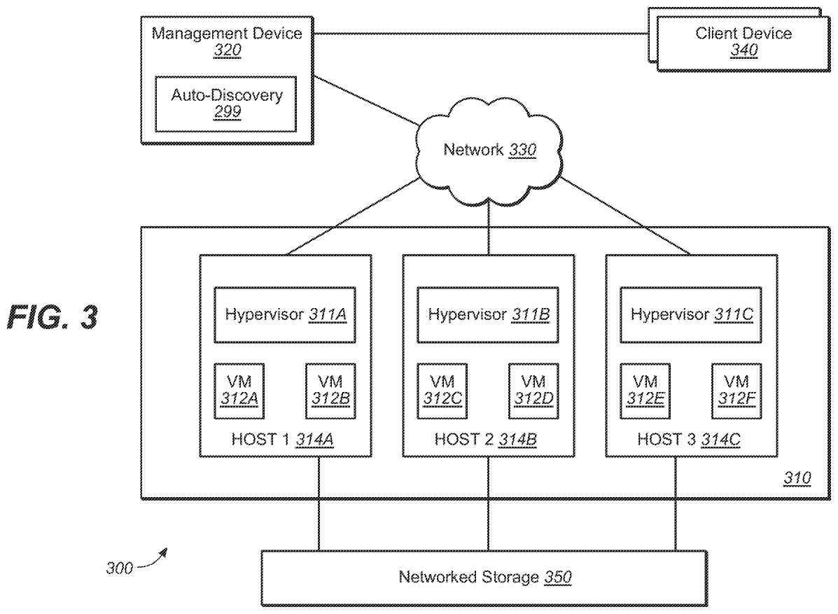

With reference now to FIG. 2, all or portions of some embodiments described herein are composed of computer-readable and computer-executable instructions that reside, for example, in computer-usable/computer-readable storage media of a computer system. That is, FIG. 2 illustrates one example of a type of computer (computer system 200) that can be used in accordance with or to implement various embodiments which are discussed herein. It is appreciated that computer system 200 of FIG. 2 is only an example and that embodiments as described herein can operate on or within a number of different computer systems including, but not limited to, general purpose networked computer systems, embedded computer systems, routers, switches, server devices, client devices, various intermediate devices/nodes, standalone computer systems, media centers, handheld computer systems, multi-media devices, virtual machines, virtualization management servers, and the like. Computer system 200 of FIG. 3 is well adapted to having peripheral tangible computer-readable storage media 202 such as, for example, an electronic flash memory data storage device, a floppy disc, a compact disc, digital versatile disc, other disc based storage, universal serial bus “thumb” drive, removable memory card, and the like coupled thereto. The tangible computer-readable storage media is non-transitory in nature.

System 200 of FIG. 2 includes an address/data bus 204 for communicating information, and a plurality of processor 206 coupled with bus 204 for processing information and instructions. As depicted in FIG. 2, system 200 is also well suited to a multi-processor environment in which a plurality of processors 206 are present. Conversely, system 200 is also well suited to having a single processor such as, for example, processor 206. Processor 206 may be any of various types of microprocessors. System 200 also includes data storage features such as a computer usable volatile memory 208, e.g., random access memory (RAM), coupled with bus 204 for storing information and instructions for processor 206.

System 200 also includes computer usable non-volatile memory 210, e.g., read only memory (ROM), coupled with bus 204 for storing static information and instructions for processor 206. Also present in system 100 is a data storage unit 212 (e.g., a magnetic or optical disc and disc drive) coupled with bus 204 for storing information and instructions. System 200 also includes an alphanumeric input device 214 including alphanumeric and function keys coupled with bus 204 for communicating information and command selections to one or more of processor 206. System 200 also includes a cursor control device 216 coupled with bus 204 for communicating user input information and command selections to one or more of processor 206. In one embodiment, system 200 also includes a display device 218 coupled with bus 204 for displaying information.

Referring still to FIG. 2, display device 218 of FIG. 2 may be a liquid crystal device (LCD), light emitting diode display (LED) device, cathode ray tube (CRT), plasma display device, a touch screen device, or other display device suitable for creating graphic images and alphanumeric characters recognizable to a user. Cursor control device 216 allows the computer user to dynamically signal the movement of a visible symbol (cursor) on a display screen of display device 218 and indicate user selections of selectable items displayed on display device 218.

Many implementations of cursor control device 216 are known in the art including a trackball, mouse, touch pad, touch screen, joystick or special keys on alphanumeric input device 214 capable of signaling movement of a given direction or manner of displacement. Alternatively, it will be appreciated that a cursor can be directed and/or activated via input from alphanumeric input device 214 using special keys and key sequence commands. System 200 is also well suited to having a cursor directed by other means such as, for example, voice commands. In various embodiments, alpha-numeric input device 214, cursor control device 216, and display device 218, or any combination thereof (e.g., user interface selection devices), may collectively operate to provide a graphical user interface (GUI) 230 under the direction of a processor (e.g., processor 206). GUI 230 allows user to interact with system 200 through graphical representations presented on display device 218 by interacting with alpha-numeric input device 214 and/or cursor control device 216.

System 200 also includes an I/O device 220 for coupling system 200 with external entities. For example, in one embodiment, I/O device 220 is a modem for enabling wired or wireless communications between system 200 and an external network such as, but not limited to, the Internet.

Referring still to FIG. 2, various other components are depicted for system 200. Specifically, when present, an operating system 222, applications 224, modules 226, and data 228 are shown as typically residing in one or some combination of computer usable volatile memory 208 (e.g., RAM), computer usable non-volatile memory 210 (e.g., ROM), and data storage unit 212. In some embodiments, all or portions of various embodiments described herein are stored, for example, as an application 224 and/or module 226 in memory locations within RAM 208, computer-readable storage media within data storage unit 212, peripheral computer-readable storage media 202, and/or other tangible computer-readable storage media.

### Brief Overview

First, a brief overview of an embodiment of the present machine learning based application discovery using netflow information invention, is provided below. Various embodiments of the present invention provide a method and system for automated feature selection within a machine learning within a virtual machine computing network environment.

More specifically, the various embodiments of the present invention provide a novel approach for automatically providing identifying communication patterns between virtual machines (VMs) of different instantiations in a virtual computing network environment to discover applications and tiers of the applications across various components in order to improve access and optimize network traffic by clustering application with a common host in the computing environment. In one embodiment, an IT administrator (or other entity such as, but not limited to, a user/company/organization etc.) registers multiple number of machines or components, such as, for example, virtual machines onto a network system platform, such as, for example, virtual networking products from VMware, Inc. of Palo Alto.

In the present embodiment, the IT administrator is not required to generate agent-based application discovery through any extraneous operating system intrusions of the virtual machines with the corresponding service type or indicate the importance of the particular machine or component. Further, the IT administrator is not required to manually list only those machines or components which the IT administrator feels warrant protection from excessive network traffic utilization. Instead, and as will be described below in detail, in various embodiments, the present invention, will automatically determine which applications and tiers with the associated machines or components are to be monitored by machine learning.

As will also be described below, in various embodiments, the present invention is a computing module which integrated within an application discovery monitoring and optimization system. In various embodiments, the present application discovery and optimization invention, will itself identify application span across multiple diverse virtual machines and determines the associations of these application and clusters the application so that that the application being hosted by a common host are grouped together for easy access and identification after observing the activity by each of the machines or components for a period of time in the computing environment thereby enabling the machines to automatically learn where and how to access these applications and the iterations thereof.

Additionally, for purposes of brevity and clarity, the present application will refer to “machines or components” of a computing environment. It should be noted that for purposes of the present application, the terms “machines or components” is intended to encompass physical (e.g., hardware and software based) computing machines, physical components (such as, for example, physical modules or portions of physical computing machines) which comprise such physical computing machines, aggregations or combination of various physical computing machines, aggregations or combinations or various physical components and the like. Further, it should be noted that for purposes of the present application, the terms “machines or components” is also intended to encompass virtualized (e.g., virtual and software based) computing machines, virtual components (such as, for example, virtual modules or portions of virtual computing machines) which comprise such virtual computing machines, aggregations or combination of various virtual computing machines, aggregations or combinations or various virtual components and the like.

Additionally, for purposes of brevity and clarity, the present application will refer to machines or components of a computing environment. It should be noted that for purposes of the present application, the term “computing environment” is intended to encompass any computing environment (e.g., a plurality of coupled computing machines or components including, but not limited to, a networked plurality of computing devices, a neural network, a machine learning environment, and the like). Further, in the present application, the computing environment may be comprised of only physical computing machines, only virtualized computing machines, or, more likely, some combination of physical and virtualized computing machines.

Furthermore, again for purposes and brevity and clarity, the following description of the various embodiments of the present invention, will be described as integrated within a machine learning based applications discovery system. Importantly, although the description and examples herein refer to embodiments of the present invention integrated within a machine learning based applications discovery system with, for example, its corresponding set of functions, it should be understood that the embodiments of the present invention are well suited to not being integrated into a machine learning based applications discovery system and operating separately from a machine learning based applications discovery system. Specifically, embodiments of the present invention can be integrated into a system other than a machine learning based applications discovery system.

Embodiments of the present invention can operate as a standalone module without requiring integration into another system. In such an embodiment, results from the present invention regarding feature selection and/or the importance of various machines or components of a computing environment can then be provided as desired to a separate system or to an end user such as, for example, an IT administrator.

Importantly, the embodiments of the present machine learning based application discovery invention significantly extend what was previously possible with respect to providing applications monitoring tools for machines or components of a computing environment. Various embodiments of the present machine learning based application discovery invention enable the improved capabilities while reducing reliance upon, for example, an IT administrator, to manually monitor and register various machines or components of a computing environment for applications monitoring and tracking. This contrasts with conventional approaches for providing applications discovery tools to various machines or components of a computing environment which highly dependent upon the skill and knowledge of a system administrator. Thus, embodiments of present network topology optimization invention provide a methodology which extends well beyond what was previously known.

Also, although certain components are depicted in, for example, embodiments of the machine learning based applications discovery invention, it should be understood that, for purposes of clarity and brevity, each of the components may themselves be comprised of numerous modules or macros which are not shown.

Procedures of the present machine learning based automated application discovery using network flows information invention are performed in conjunction with various computer software and/or hardware components. It is appreciated that in some embodiments, the procedures may be performed in a different order than described above, and that some of the described procedures may not be performed, and/or that one or more additional procedures to those described may be performed. Further some procedures, in various embodiments, are carried out by one or more processors under the control of computer-readable and computer-executable instructions that are stored on non-transitory computer-readable storage media. It is further appreciated that one or more procedures of the present may be implemented in hardware, or a combination of hardware with firmware and/or software.

Hence, the embodiments of the present machine learning based applications discovery invention greatly extend beyond conventional methods for providing application discovery in machines or components of a computing environment. Moreover, embodiments of the present invention amount to significantly more than merely using a computer to provide conventional applications monitoring measures to machines or components of a computing environment. Instead, embodiments of the present invention specifically recite a novel process, necessarily rooted in computer technology, for improving network communication within a virtual computing environment.

Additionally, as will be described in detail below, embodiments of the present invention provide a machine learning based application discovery system including a novel search feature for machines or components (including, but not limited to, virtual machines) of the computing environment. The novel search feature of the present network optimization system enables ends users to readily assign the proper and scopes and services the machines or components of the computing environment, Moreover, the novel search feature of the present applications discovery system enables end users to identify various machines or components (including, but not limited to, virtual machines) similar to given and/or previously identified machines or components (including, but not limited to, virtual machines) when such machines or component satisfy a particular given criteria and are moved within the computing environment. Hence, as will be described in detail below, in embodiments of the present security system, the novel search feature functions by finding or identifying the “siblings” of various other machines or components (including, but not limited to, virtual machines) within the computing environment.

### Continued Detailed Description of Embodiments after Brief Overview

As stated above, feature selection which is also known as “variable selection”, “attribute selection” and the like, is an import process of machine learning. The process of feature selection helps to determine which features are most relevant or important to use to create a machine learning model (predictive model).

In embodiments of the present invention, a network topology optimization system such as, for example, provided in virtual machines from VMware, Inc. of Palo Alto, California will utilize a network flow identification method to automatically identify application span across computing components and take remediation steps to improve discovery and access in the computing environment. That is, as will be described in detail below, in embodiments of the present network topology optimization invention, a computing module, such as, for example, the application discovery module 299 of FIG. 2, is coupled with a computing environment.

Additionally, it should be understood that in embodiments of the present machine learning based applications discovery module 299 of FIG. 2 may be integrated with one or more of the various components of FIG. 2. Application discovery module 299 then automatically evaluates the various machines or components of the computing environment to determine the importance of various features within the computing environment.

Additionally, in one embodiment, the network optimizer of the present invention, micro-segments the network domain to enhance network traffic

Several selection methodologies are currently utilized in the art of feature selection. The common selection algorithms include three classes: Filter Methods, Wrapper Methods and Embedded Methods. In Filter Methods, scores are assigned to each feature based on a statistical measurement. The features are then ranked by their scores and are either selected to be kept as relevant features or they are deemed to not be relevant features and are removed from or not included in dataset of those features defined as relevant features. One of the most popular algorithms of the Filter Methods classification is the Chi Squared Test. Algorithms in the Wrapper Methods classification consider the selection of a set of features as a search result from the best combinations. One such example from the Wrapper Methods classification is called the “recursive feature elimination” algorithm. Finally, algorithms in the Embedded Methods classification learn features while the machine learning model is being created, instead of prior to the building of the model. Examples of Embedded Method algorithms include the “LASSO” algorithm and the “Elastic Net” algorithm.

Embodiments of the present application discovery invention utilize a statistic model to determine the importance of a particular feature within, for example, a machine learning environment.

With reference now to FIG. 3, a block diagram of an exemplary virtual network system 300, in accordance with one embodiment of the present invention.

Cluster 310 utilizes a host group 310 with a first host 314A, a second host 314B and a third host 314C. Each host 314A—314C executes one or more VM nodes 312A-312F of a distributed computing environment. For example, in the embodiment in FIG. 3, first host 314A executes a first hypervisor 311A, a first VM node 312A and a second VM node 312B, Second host 314B executes a second hypervisor 311B and VM nodes 312C-312D and third host 314C executes hypervisor 311C and VM nodes 312E-312F. Although FIG. 3 depicts only three hosts in host group, it should be recognized that a host group in alternative embodiments may include any quantity of hosts executing any number of VM nodes and hypervisors. As previously discussed in the context of FIG. 3, VM nodes running in host may execute one or more distributed software components of the distributed computing environment.

VM nodes in hosts 310 communicate with each other via a network 330. For example, the NameNode the functionality of a master VM node may communicate with the Data Node functionality via network 330 to store, delete, and/or copy a data file using a server filesystem. As depicted in the embodiment in FIG. 3, cluster 300 also includes a management device 320 that is also networked with hosts 310 via network 330. Management device 320 executes a virtualization management application (e.g., VMware vCenter Server, etc.) and a cluster management application. Virtualization management application monitors and controls hypervisors executed by host 310, to instruct such hypervisors to initiate and/or to terminate execution of VMs such as VM nodes. In one embodiment, cluster management application communicates with virtualization management application in order to configure and manage VM nodes in hosts 310 for use by the distributed computing environment. It should be recognized that in alternative embodiments, virtualization management application and cluster management application may be implemented as one or more VMs running in a host in the laaS or data center environment or may be a separate computing device.

As further depicted in FIG. 3, user of the distributed computing environment service may utilize a user interface on a remote client device to communicate with cluster management application in management device. For example, client device may communicate with management device using a wide area network (WAN), the internet, and/or any other network. In one embodiment, the user interface is a web page of a web application component of cluster management application that is rendered in a web browser running on a user's laptop. The user interface may enable a user to provide a cluster size data sets, data processing code and other preferences and configuration information to cluster management in order to launch cluster to perform a data processing job on the provided data sets. It should be recognized, in alternative embodiments, cluster management application may further provide an application programming interface (“API”) in addition supporting the user interface to enable users to programmatically launch or otherwise access clusters to process data sets. It should further be recognized that cluster management application may provide an interface for an administrator. For example, in one embodiment, an administrator may communicate with cluster management application through a client-side application, in order to configure and manage VM nodes in hosts 310 for example.

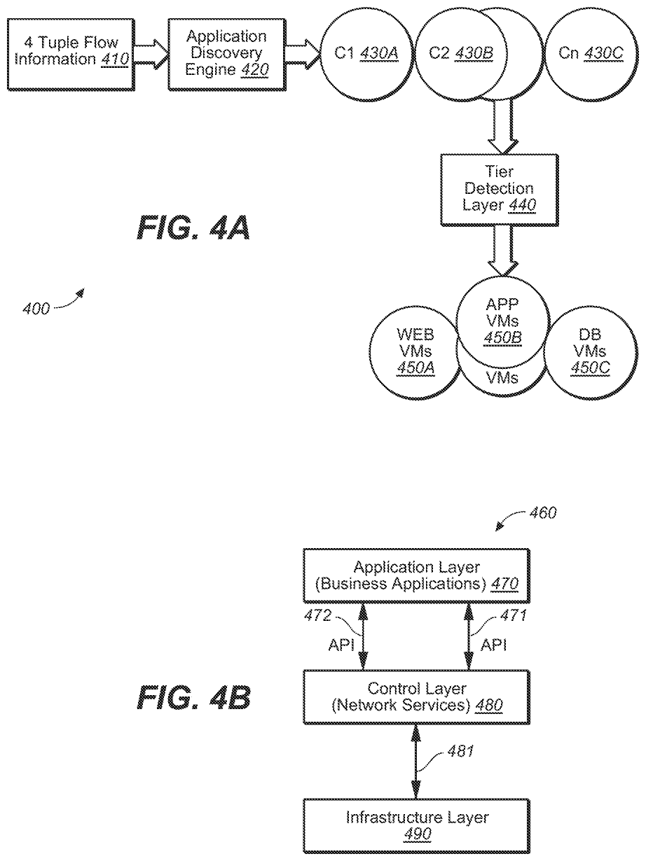

With reference now to FIG. 4A, a block diagram of an exemplary workflow approach 400 of one embodiment of the machine learning based application discovery invention is shown. The present invention provides an agent-less, vendor agnostic and secure way to discover applications and tiers thereof in a computing environment automatically. The approach 400 depicted in FIG. 4 only requires a datacenter network flow information and their endpoints (i.e., VMs) in order to affect the machine learning principles of the invention.

Still referring to FIG. 4A, the netflow information is provided 410 to the application discovery engine 420 for processing. In one embodiment, the flow information is sourced from, for example, NetFlow, vDS IPFix and AWS flow logs. The application discovery engine 420 processes the input information to generate communication graphs of the various endpoints (C1 . . . Cn) 430. The communication graphs are then presented to the tier detection component 440 where the endpoint communication graph corresponding to a single application are segregated into multiple tiers based on the similarities in the pattern of the hosting and accessed points of the endpoints.

In one embodiment, the machine learning approach is based on the principles that the overlap in terms of communication profile for a pair of endpoints from the same application is greater than that for a pair of endpoints from different application. Also, the communication graph, the degree of connectivity within an application is significantly greater than the degrees of connectivity between two distinct applications. The similarity of the communication profile and degree of connectivity of endpoints can be exploited to perform the effective clustering of endpoints. Based on these principles the discovery engine 420 utilizes a vector encoding of an endpoint based on the communication patterns with the other endpoints. All endpoints are treated as individual dimensions. The component of the vector in the individual dimension is based on the communication pattern with the corresponding endpoint. In one embodiment, the endpoint could also be treated as a point in the multi-dimensional Euclidean space and coordinates of the point is derived from its vector encoding.

In one embodiment, a set of endpoints which belong to the same application would have the same coordinates values in most of the dimensions whereas the same would not be true for two endpoints of different application. This may be represented by the formula

V(X₁−y₁)²+(x₂−y₂)²+ . . . +(Xₙ−yₙ)²

Based on the Euclidean distance metric, the endpoints corresponding to the same application would relatively be in close proximity to each other compared to endpoints of different applications implemented by the present invention. In one embodiment, the identified application endpoints can be coupled to an application by utilizing micro-segmentation rules to exclude other endpoints from the application.

In one embodiment of the invention, the application boundary endpoints locations (but not necessarily requiring knowledge of the corresponding application's location) are used to define a software defined network to enhance, for example, the security of the application or the computing network environment. As shown in FIG. 4B, the software-defined network comprises an applications layer 470, a control layer 480 and an infrastructure layer 490. The SDN 460 enables dynamic, programmatic efficient network configuration and management in order to improve network performance and monitoring making it more like a cloud computing than a traditional network management, SDN 460 is meant to address the fact that the static architecture of traditional networks is decentralized and complex while current networks require more flexibility and easy troubleshooting. SDN 460 attempts to centralize network intelligence in one network component by disassociating the forwarding process of network packets (data plane) from the routing process (control layer). The control layer consists of one or more controllers which are considered as the brain of SDN 460 network where the whole intelligence is incorporated.

In SDN 460, the network administrator can shape traffic from a centralized control console without having to touch individual switches in the network. The centralized SDN 460 controllers directs the switches to deliver network services wherever they are needed regardless of the specific connections between a server and devices. The SDN 460 architecture decouples the network control and forwarding functions enabling the network control to become directly programmable and the underlying infrastructure to be abstracted for applications and network services.

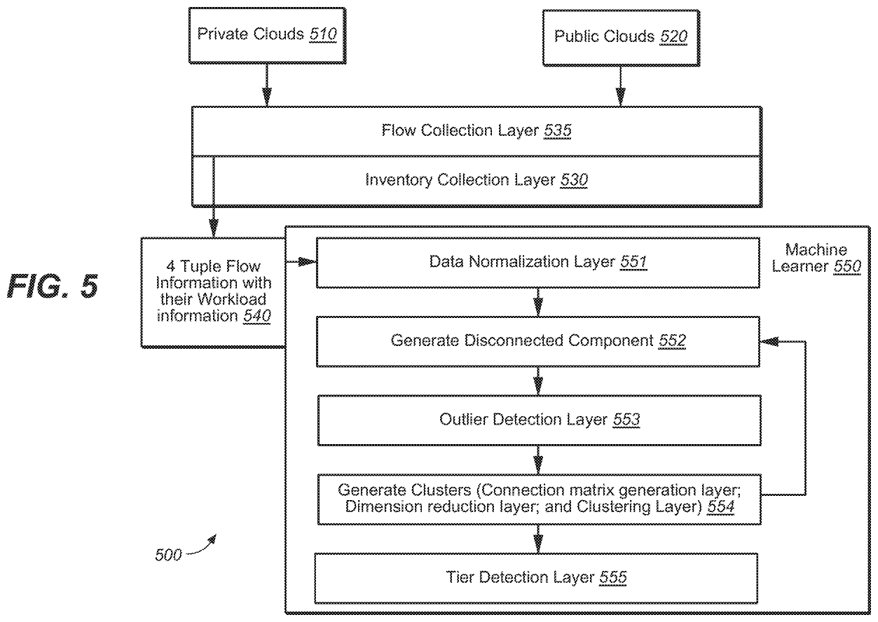

With reference now to FIG. 5, a block diagram of an exemplary components of one embodiment of the machine learning automated applications discovery 299 in accordance to an embodiment of the present invention is illustrated. As shown in FIG. 5, the computing environment 500 comprises a plurality of private cloud applications source 510, public cloud 520, flow collection component 535, inventory collection component 530, 4 Tuple flow information component 540 and machine learning based applications discovery component 550. As shown in FIG. 5, an embodiment of the present invention goes through multiple processing layers. Each layer has a critical functionality which can be independently implemented and optimized. As shown in FIG. 5, in one embodiment network flow data is generated from private cloud component 510 and together with public cloud flow data from public cloud component 520 and provided to flow collection layer. In one embodiment, the flow collection component 535 resides in the virtual realize network insight component (vRNI) in a host machine.

The flow layer 535 collects flows from the private cloud 510 and public cloud 520 using, for example, NetFlow and Flow Watcher logs respectively. The flow collection component 535 also collects VM inventory snapshots. With the help of inventory details, flow tuple information provided by 4 Tuple flow information component 540 is enriched with workload information. In one embodiment, the vRNI also enriches flows with traffic type information (e.g., for example East-West and North-South based on RFC 1918 Address Allocation for Private Internets).

Still referring to FIG. 5, machine learner 550 provides an automated machine learning based application discovery of applications and their related tiers across multiple and, sometimes, diverse computing components. In one embodiment, the machine learner 550 implements data normalization 551, generate disconnected component 552, outlier detection of components 553, generate clusters 554 and tier detection 555.

The data normalization layer 551 filters out the flow information provided by flow collection 535. In one embodiment, the filtering of the flow data is based on the exclusion of flow data corresponding to Internet traffic and the exclusion of flow data based on user feedback in terms of subnets and port ranges. The data normalizer 551 optimizes the accuracy and time-complexity of the overall discovery process. Data normalization is important as flow data corresponding to dynamic server port or SSH traffic are not important communications from the perspective of identifying application and tier boundaries. For the user-case of application discovery these communications can be seen as noise data as these don't reveal any useful information about the application topology in the datacenter.

Disconnected component layer 552 takes normalized flow data as input. A communication graph is built based on the input flow data. In this graph, nodes correspond to endpoints and the directed edges between nodes represent communication between endpoints. Each of the edges in the communication graph can output is annotated with port information as metadata. Construction of the communication graph can output one or more weakly connected components. Each Weakly connected component is considered separately because in general, it would be the case that an application spans across multiple weakly connected components

Still referring to FIG. 5, outlier detection layer 523 detects outlier in the input graph. The outlier detection layer 553 helps determine whether the input communication graph requires further refinement based on the presence of common services. Node representing common services would generally have high in-degree or out-degree in the endpoint communication graph. In one embodiment to detect outlier nodes, a table is created that contains in-degree and out-degree of each node and perform a univariate analysis on in-degree and out-degree of nodes to find outliers using, for example, the MAD algorithm.

The clustering layer 554 takes endpoint communication graph as input and generates clusters of endpoints. An output cluster would contain the endpoints of similar communication patterns. In one embedment, the cluster layer 554 includes a connection matrix generation component, a dimension reduction component and a clustering component. The clustering layer 554 comprise the step of vectorization of endpoints, dimensionality reduction and clusters. In vectoring the endpoints, the adjacency matrix of the endpoint communication graph is created. For N endpoints a N*N adjacency matrix is created. Each row of the matrix corresponding to an endpoint can be seen as the vector representation of that endpoint in N dimension.

In reducing the dimensionality of the endpoints, for large number of endpoints (e.g., N endpoints) a clustering algorithm cannot be performed directly on the N-dimensional representation of endpoints obtained from the vectorization process. So, a PCA based on singular value decomposition to reduce the number of dimensions is used. To choose the optimal number of dimensions the cumulative explained variance ratio is used as a function of the number of dimensions, the optimal number of dimensions should retain 90% of the variance. Using PCA a representation of endpoints in lower dimensional space such that the variance in the reduced dimensional space is maximized.

After the dimensionality reduction, clustering of the datapoints is performed. In one embodiment, two different clustering algorithms may be used. In a first instance, k-means++ algorithm is used to run cluster with random values of initial cluster centers. A Sum of square distances analysis is used to optimize the final set of clusters and the number of iterations to get the final cluster. Even though the running time of k-means++ is better than other clustering algorithms but is does not show good results with noisy data or outliers.

Still with reference to FIG. 5, the tier detection layer 555 takes the endpoints communication graph corresponding to a single application as input and then segregates the endpoints within the application into multiple tiers. In this case, the grouping criterion based on similarities in the pattern of hosted and accessed ports, are considered to be part of the same tier, i.e., vectorization of endpoints works a bit differently.

In one embodiment, all parts of an application are retrieved and two tags for each port is created (e.g., for port 442 two tags are created-Hosted 443, Accessed: 443). A matrix with the tags created are matrixed as columns. Each row of the matrix would correspond to an endpoint. If an endpoint is hosting port 443 then the corresponding cell (Hosted:443) in the matrix is marked as 1 (otherwise 0), similarly, if an endpoint is accessing port 443 then the corresponding cell (Accessed: 443) is marked as 1 (otherwise 0). The columns of the above connection matrix represent the multiple dimensions of the endpoint vector. After that, the dimension reduction algorithm and clustering algorithms are applied to group endpoints within an application across multiple tiers.

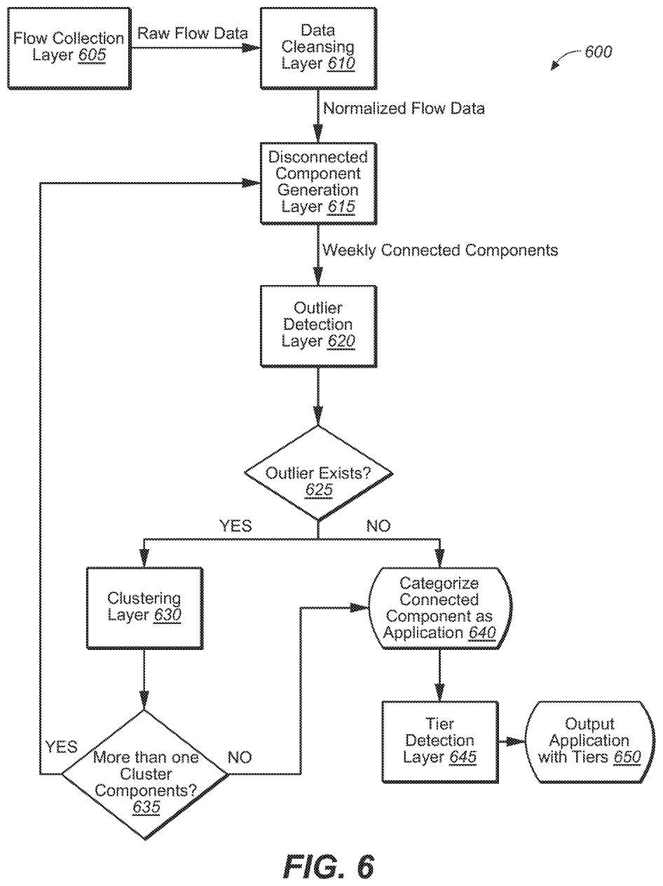

Referring now to FIG. 6, a flow chart of an applications detection workflow process in accordance to one embodiment of the present invention is depicted. As shown at Step 610 the automated application discovery process starts with the collection of enriched flow data from vRNI and forwards the data to data cleansing step 610. At Step 610, the flow data is filtered and then passed on to the disconnected component generation step 615.

At the disconnected component generation step 615, a network communication graph is created based on the input flow data and then produces multiple weakly connected components as output. In one embodiment, for each weakly connected component, an outlier detection is invoked. At outlier detection step 620, a check of the existence is made at Step 625. If any outliers are detected, processing continues at step 630 where the data flow presented to the outlier is forwarded to clustering layer and processing continues at step 630. If on the other hand, no outliers are detected, processing continues at step 640 where the data flow presented to the outlier at step 630 is classified as an application.

At Step 630, if the cluster layer finds more than one cluster in the input connected component a determination is made at step 635 if more than one cluster component is present. If more than one cluster component is present, the information is forwarded to the disconnected component generation at step 615 for processing. If on the other hand, a single cluster component is detected at step 635, the information is forwarded to step 640 where the connected component information is categorized as an application.

At Step 645 the application component from step 640 is processed to be associated with its corresponding tiers.

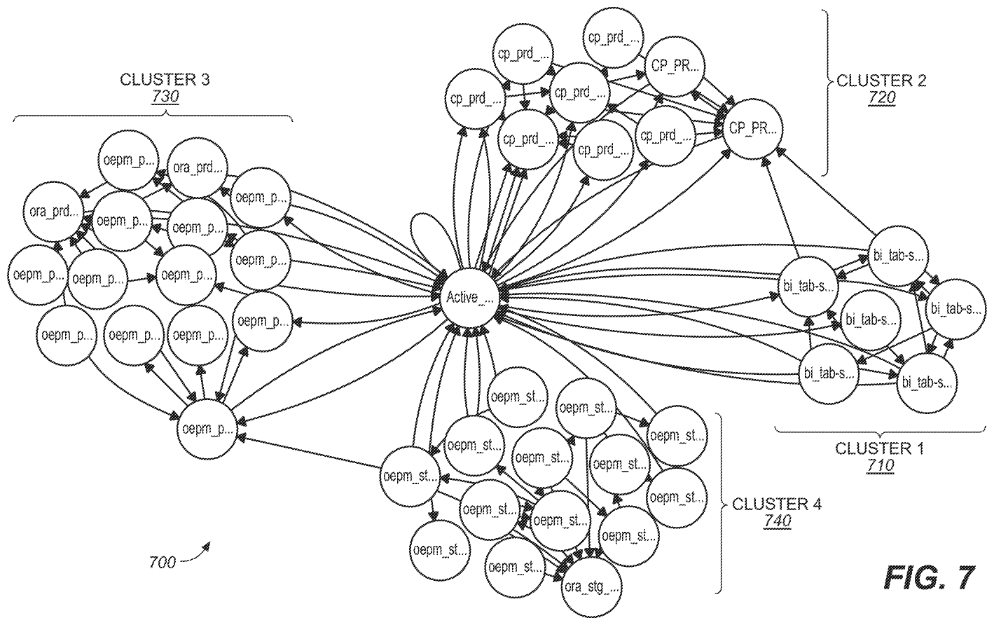

FIG. 7 is an exemplary topology diagram showing an exemplary communication pattern of a selected set of applications in an exemplary IT computing environment. The computer environment topology depicted in FIG. 7 is based on an exemplary environment in the VMware Software Defined Data Center (SDDC) computing environment. As shown in FIG. 7, the auto-discovery invention 299 identifies 5 separate clusters-Cluster 1-Cluster5. Cluster 1 corresponds to Ocpm Staging, Cluster 2 corresponds to Oepm Prod, Cluster3 correspond to BI Tab, Cluster4 corresponds to CP Prod and Cluster5 corresponds to Active Directory application groups. Only one VM of Active Directory (Cluster5) is shown to keep the virtualization simple.

Based on the application defined by the applications administrator in the computing environment (e.g., VMware's SDDC computing platform), Oepm Staging and Oepm Prod groups should have been part of the same application. However, based on the observed communication patterns, we can see that there are too many communication links within each of these groups but hardly see any communication going across these groups. Hence the present auto-detect component detects Oepm Staging and Oepm Prod groups as two separate applications based on the communication patterns.

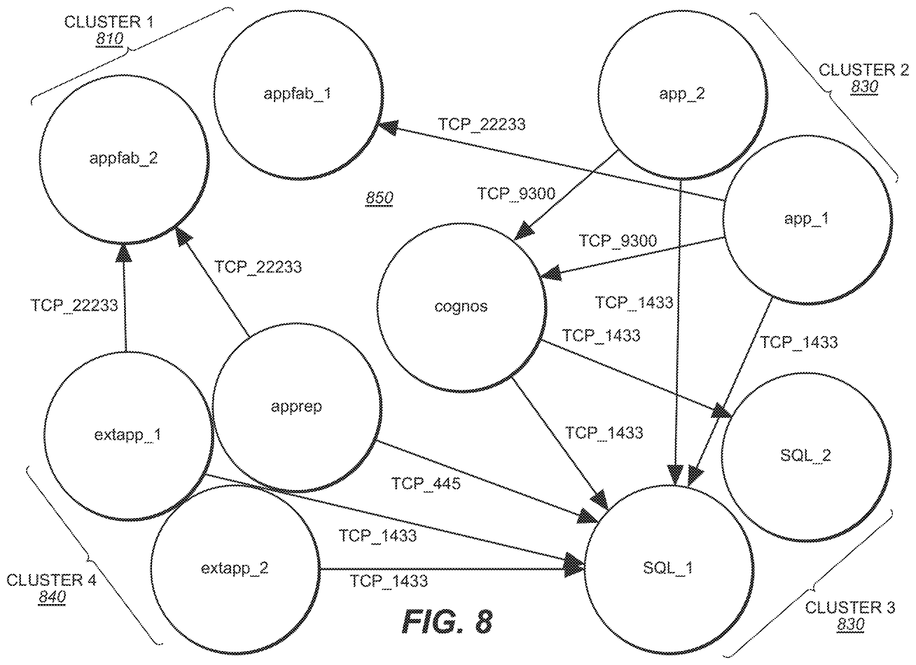

Referring now to FIG. 8, an exemplary applications topology of the application of one embodiment of the auto-detect method in accordance to one embodiment of the present invention is shown. The environment 800 shown in FIG. 8 depicts the detection and segregation of endpoints in a computing environment. As shown although the endpoints span across multiple tiers for an identified application (e.g., ChangePoint) in the SDDC environment, the endpoints of each tier have the same hosted ports or accessed ports, for example, SQL-1 and SQL-2 are part of the same tier as they are hosting TCP connection on port 1433. Hence the endpoints are segregated and clustered for automatic discovery.

Once again, although various embodiments of the present application discovery invention described herein refer to embodiments of the present invention integrated within a virtual computing system with, for example, its corresponding set of functions, it should be understood that the embodiments of the present invention are well suited to not being integrated into an application discovery system and operating separately from a applications discovery system. Specifically, embodiments of the present invention can be integrated into a system other than a security system. Embodiments of the present invention can operate as a standalone module without requiring integration into another system. In such an embodiment, results from the present invention regarding feature selection and/or the importance of various machines or components of a computing environment can then be provided as desired to a separate system or to an end user such as, for example, an IT administrator.

Additionally, embodiments of the present invention provide a machine learning based application discovery system including a novel search feature for machines or components (including, but not limited to, virtual machines) of the computing environment. The novel search feature of the present machine learning based applications discovery system enables ends users to readily assign the proper and scopes and services the machines or components of the computing environment, Moreover, the novel search feature of the present machine learning based application discovery system enables end users to identify various machines or components (including, but not limited to, virtual machines) similar to given and/or previously identified machines or components (including, but not limited to, virtual machines) when such machines or component satisfy a particular given criteria. Hence, in embodiments of the present security system, the novel search feature functions by finding or identifying the “siblings” of various other machines or components (including, but not limited to, virtual machines) within the computing environment.

### Constraint Based Algorithms

Current enterprises prefer planning security, networking and troubleshooting of the datacenters using business Applications and Tiers. These constructs give good abstraction levels to manage infrastructure, resources and security planning.

Hence, various auto discovery of applications and tier have been proposed, for example Flow based Application discovery (FBAD). However, with only Flows data as the input the discovered applications are not as accurate as perceived by the end users. Some of the reasons are mentioned below

One reason for accuracy issues is that Flow data is missing from some of the VMs. This can happen due to some of the backup VMs, which are not always in communication and communicate very sporadically.

Another reason for accuracy issues stems from improper flow patterns. This happens when some of the VMs participate more than others. e.g MySQL master and slave servers have different flow patterns even though users treat then as the same application/tier.

Finally, there are challenges in the stitching of flows. Sometimes, the flow data is not accurate and does not provide end to end flows between due to various factors like NAT, Network load-balancers and other network gateways/routers. Due to this, proper flow pattern can't be established which is the core of some algorithms.

Hence, the accuracy of the applications and tiers groupings discovered by the flow based application discovery needs to be improved using other data apart from flows.

In other words, embodiments provide an improved algorithm of application discovery using runtime and configuration data with a machine learning algorithm. in one embodiment, the approach is agentless and non-intrusive. In one embodiment, the automatic application discovery mechanism is vendor agnostic. In one embodiment, the algorithm can work with any constraint provided by the user, or the constraints can be automatically generated using the configuration data of the computing environment. In one embodiment, a constraint is a rule that an algorithm has to follow.

In one embodiment, Flow Based Application Discovery Pipelines (FBAD) as discussed currently do not take into account data that comes from Load Balancers across the network. Load Balancers can provide important data as two Virtual Machines (VM) belonging to the same Load Balancer VIP are most likely part of the same application. This data allows there to be constraints which show a user which Virtual Machines are in the same known application. These constraints need to be integrated with the existing FBAD Pipeline.

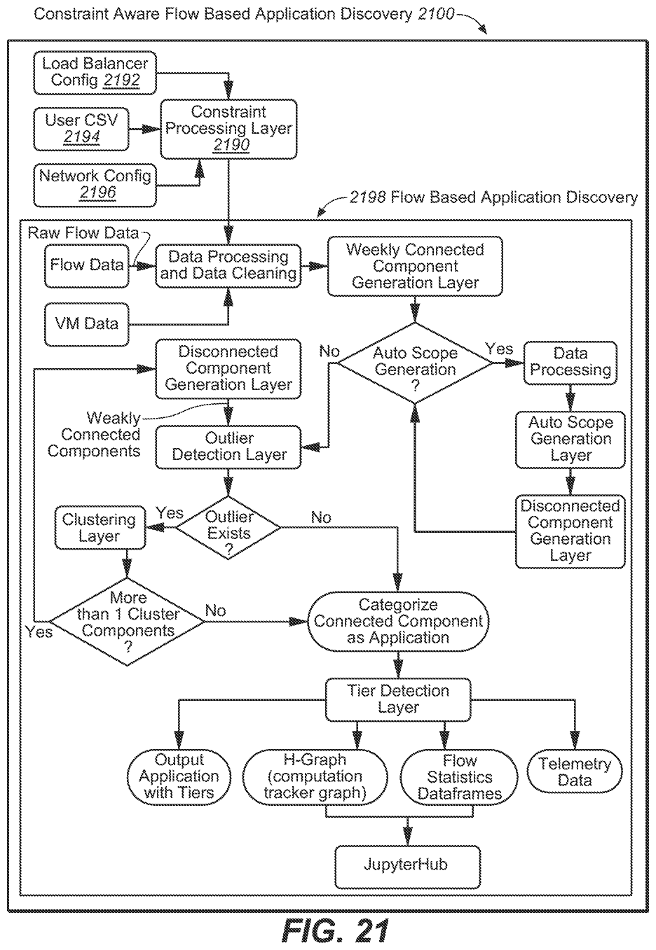

FIG. 21 shows a diagram of a constraint aware Flow Based Application Discovery 2100 pipeline. Included are the constraint processing layer 2190, the load balancer config data 2192, the user input example csv 2194, network device config data 2196, and the FBAD pipeline 2198.

In one embodiment, the Constraint Processing Layer 2190 is responsible for generating different types of constraints (e.g., MUST, MUST_NOT) based on load balancer config data 2192, user input example csv 2194, and network device config data 2196. In one embodiment, the Semi Supervised algorithm uses supervised data (config data) from the output of the Constraint Processing layer 2190. In one embodiment, the Constraint processing layer is responsible for generating a set of constraints based on network flow information.

Flow based application discovery is based on Hierarchical Clustering which does clustering based on the flow data between the VMs. This probabilistic unsupervised ML algorithm uses flow patterns to identify application and tier boundaries.

Due to the aforementioned issues, some of the VMs of the application gets distributed across multiple applications which is not intended.

In one embodiment, a Constraint aware Flow based algorithm which can accept various constraints (rules) between VMs is used. In one embodiment, the constraint aware flow based algorithm is a constraint based semi supervised process.

For example, knowing which VMs belong to the same pool can be determined from the Load Balancer Data. These VMs should be categorized as being part of the same application so they are put in a constraint of the type MUST_LINK, i.e. a constraint type stating that a set of Virtual Machines with that constraint must be in the same application. It should be ensured that as a result of the FBAD Pipeline, these constraints are satisfied.

In one embodiment, the constraints are based on user input. In one embodiment, the constraints are derived from a configuration like Load balancer or other network based configurations. In one embodiment, configuration data is derived from CMDB data, tagging on applications, CSP, or other user provided inputs. The resulting algorithm would be a semi-supervised ML algorithm which honors the constraints provided.

In some embodiment, a semi-supervised ML algorithm is an intermediate between a supervised and an unsupervised algorithm.

For the rest of the discussion, Load balancer data will be used to illustrate the algorithm embodiments. It should be understood that while Load balancer data is used, other network-based configuration types of data may be utilized.

As an example, the following VMs were seen in a staging dataset and belong to the same Load Balancer VIP: web-prod-w1, web-prod-w2, web-prod-w3, and web-prod-w4.

These Virtual Machines must belong to the same application, but the FBAD Pipeline would mistakenly cluster them in different applications. As such, the Constraints must be integrated in a way which ensures that Virtual Machines belonging to the same Load Balancer VIP are clustered in the same application.

Two different Datasets were explored, and the constraints visualized at every node in the Hierarchal Clustering Tree. Cases where the constraints were being broken were also explored.

Some reasons constraints may be broken include missing flows (because of the time duration for flow fetching), no flow data for one VM belonging to a VIP, or because of unequal distribution of load on VMs due to the load balancer algorithm. In some cases, the constraints were being broken due to unusual communication patterns of VMs in some applications, i.e., a first VM from Application A might have a very high number of flows with VMs from Application B. This high flow number will cause that first VM to be clustered as a part of Application B. For example, in a staging dataset a web-prod VM had around 120 flows with some seplunk VMs which caused the web-prod VM to be clustered with the spelunk VMs rather than other web-prod VMs which were not communicating to the seplunk application group.

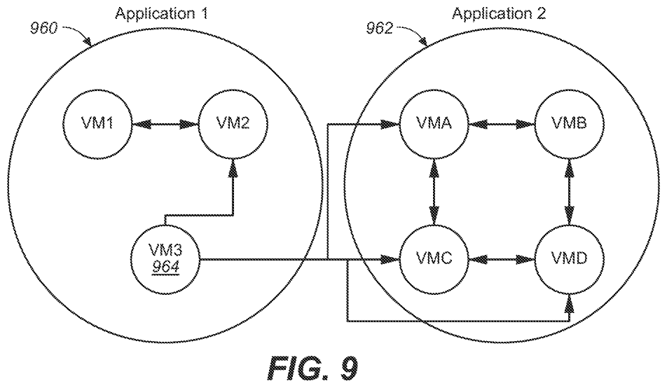

FIG. 9 shows a diagram of Application 1 960 and Application 2 962, with multiple VMs belonging to each application. In the example shown in at least FIG. 9, arrows denote the flows between VMs.

Embodiments use default FBAD algorithm and do not account for the utilization of configuration data would see VM3 964 mistakenly get clustered as a part of Application 2 962 rather than in Application 1 960 due to VM3 964 having a larger number of flows with VMs from Application 2 962.

By exploring how many constraints were being broken at every level and how many constraints were being satisfied in total for various datasets, it was found out that a good number of constraints were being broken during the clustering. Ideally, it is expected that the constraints should not be broken during the algorithm. These constraints can work as supervised data for the algorithm. By applying the constraints to the algorithm as a supervised data the precision of the algorithm should increase.

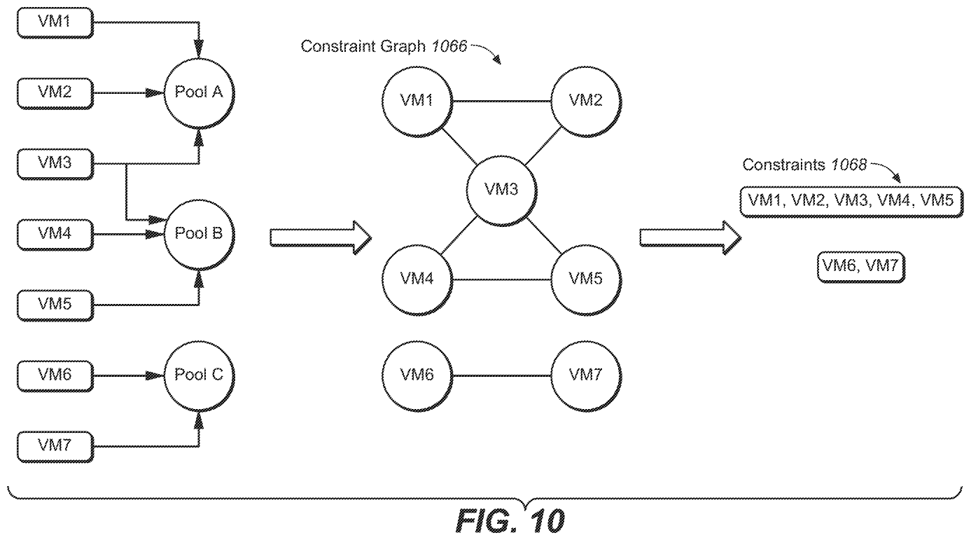

FIG. 10 shows a graph outlining the constraints assigned to an example set of VMs.

In one embodiment, the constraints are derived from the data collected by the load balancer. In the load balancer data, there is information on which VM belongs to which pool. If multiple VMs belong to the same pool, then they are assigned a MUST_LINK constraint. However, one VM can be part of multiple pools. In order to build constraints, all the pools a VM belongs to need to be considered, and then all the members of all the relevant pools with common VMs are taken and merged as one MUST_LINK constraint.

In order to properly assign any MUST_LINK constraints, an undirected constraint graph 1066 is built. Constraint graph 1066 is built using the known VMs (e.g., VM1, VM2, VM3 . . . . VMn) and the pools that those VMs belong to. In the constraint graph 1066 there are VMs as nodes and two VMs have an edge between them if they belong to the same pool.

For example, in FIG. 10 VM3 is shown to belong to Pool A as well as Pool B. Pool A also includes VM1 and VM2, while Pool B also includes VM4 and VM5. In the constraint graph 1066 VM3 is shown to be linked to VM1, VM2, VM4, and VM5. Meanwhile, VM6 is shown to belong to Pool C with VM7, and those are connected by and edge in the constraint graph 1066 separate from the VMs of Pool A and Pool B.

From this graph, connected components and VMs that belong to the same connected component are referred to as being in a MUST_LINK constraint. So, from FIG. 10, VM6 and VM7 are in a MUST_LINK constraint, whereas VM6 and VM1 are not in such a constraint.

As a result of the constraint graph 1066 the final constraints 1068 in this example will have VM1, VM2, VM3, VM4, and VM5 as a first MUST_LINK constraint group, and VM6 with VM7 as a second MUST_LINK constraint group.

In order to integrate the determined constraints into the FBAD pipeline output, there are various algorithms that may be utilized. These algorithms include a constraint based boosting algorithm, a super node based boosting algorithm, and a fast embed based boosting algorithm. The constraint based boosting algorithm uses the constraint on an output clustering algorithm to satisfy the broken constraints. The super node based boosting algorithm uses the constraints before the clustering algorithm by generating artificial nodes. Finally, the fast embed based boosting algorithm converts the constraints into the embedding and improves the existing embedding layer before iterative clustering.

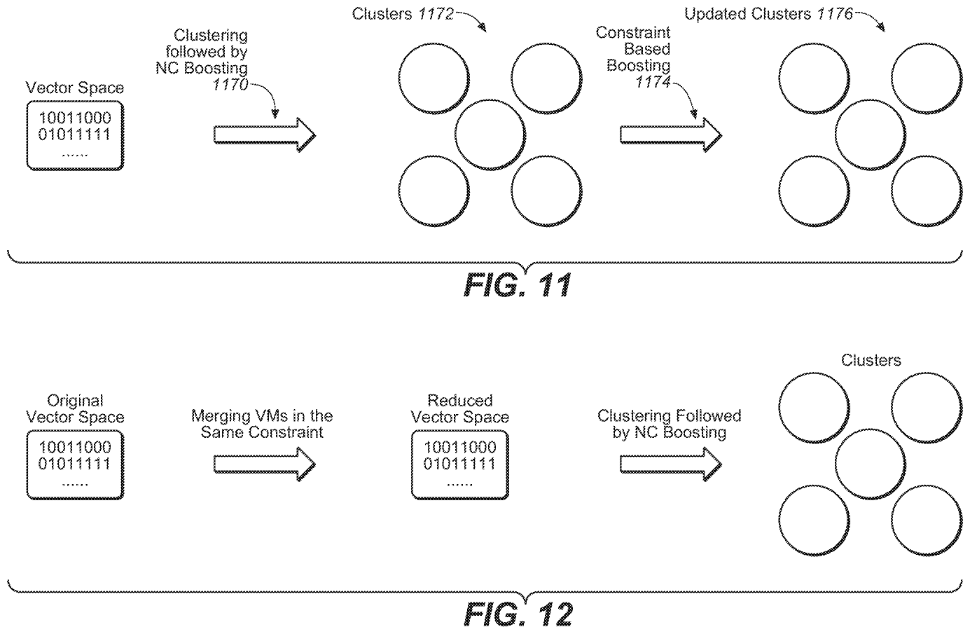

In one embodiment, a constraints based boosting algorithm is used for supervising the clustering algorithm with constraints. The constraint based boosting algorithm is a constraint based semi supervised process wherein a set of constraints are used to merge a set of nodes before an iterative clustering process. FIG. 11 shows a diagram of boosting based semi supervised iterative clustering algorithm.

After the clustering at some node during the Hierarchal Clustering, and after NC_Boosting 1170 takes place, there will be a check done on the resulting clusters 1172 to see if any of the MUST_LINK constraints were broken in the process. After the check (constraint based boosting 1174) is done, if any MUST_LINK constraints were not followed then a set of updated clusters 1176 will be formed to preserve the MUST_LINK constraints.

If VMs of a constraint are split into multiple clusters, then the VMS will be brought into a cluster which maximizes the number of connections between the VMs of constraint and the other VMs of the cluster.

For example, there are 3 VMs (VM A, VM B, and VM C) that as a result of clustering are split into 2 clusters C1 and C2. Then, all the VMs will be brought to C1 if the total number of connections between VM A, VM B, VM C, and the rest of the VMs in C1 is more than total connections between VM A, VM B, VM C, and rest of the VMs in C2. Similarly, if the number of connections between VM A, VM B, VM C, and rest of the VMs in C2 is greater than the number of connections related to C1, then VM A, VM B, and VM C will instead be brought to C2.

In one embodiment, Virtual Machines belonging to same Load Balancer VIP may not be connected via flows so, if rather than a standard clustering, the split occurs due to VMs being separated into several disconnected components, then before the split an edge is added between VMs belonging to a constraint. This would ensure the VMs remain in the same cluster. This way, no constraint gets broken.

In one embodiment, a super node approach is used is used for supervising clustering algorithm with constraints. FIG. 12 shows a diagram of clustering using a super node approach. A super node is a virtual node and is a placeholder for the VMs that are to be clustered. The constraint based super node algorithm is a constraint based semi supervised process wherein a set of constraints are used to merge a set of nodes before an iterative clustering process.

In this approach, before Clustering the data at every node a merging algorithm is applied. In one embodiment, all VMs that belong to the same cluster are merged into a single super node. Clustering is then applied on the updated data.

For merging VMs the basic Idea is that for every dimension in the representation of the Super Node, it is set to 1 if in some percentage of the VMs belonging to that super node the value at that dimension is 1. Otherwise, that dimension value is set to the average of the values at that dimension for all VMs belonging to the super node.

In one embodiment, the threshold percentage can be altered to get different results. While 0% and 100% are used as examples, numbers in between the two can be set for the threshold. In one embodiment, setting the threshold to 0% is similar to saying that if any VM is communicating with another VM, then all the other VMs attached with those two are communicating.

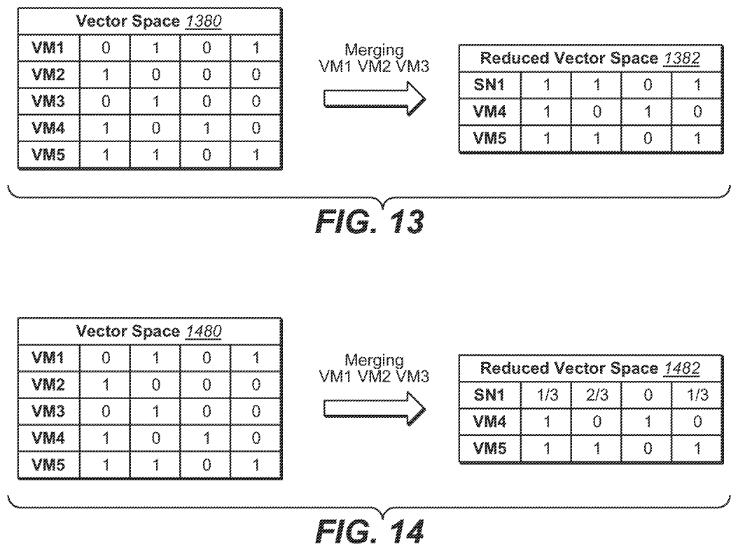

FIG. 13 shows a table of the vector space 1380 and the reduced vector space 1382 with the threshold set to 0%. In this figure, VM1, VM2 and VM3 are merged into super node 1 (SM1). Here, the values in the reduced vector space 1382 are the highest values of each column from the vector space 1380.

FIG. 14 shows a table of the vector space 1380 and the reduced vector space 1482 with the threshold set to 100%. In this figure, VM1, VM2 and VM3 are merged into super node 1 (SM1). Here, the values in the reduced vector space 1482 are the average of each column of the merged VMs from vector space 1480.

In one embodiment, changing the threshold has a significant change on the merging process. With threshold set to 0, the Super Node formed is closer in terms of Euclidean Distance to the VMs with more 1's in their representation

The reason for this is that for the two binary vectors A (Super Node) and B (a VM), the Euclidean Distance is:

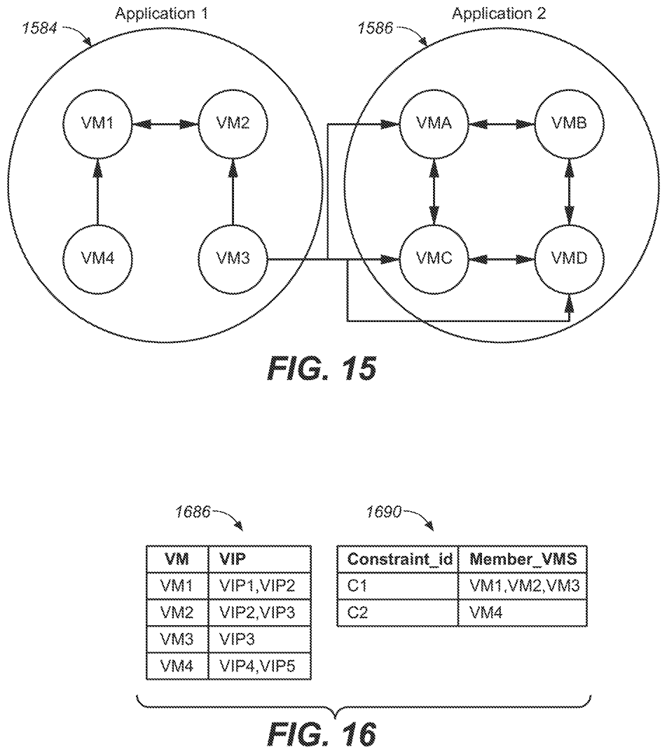

D=sqrt(a+b−2*c)=sqrt(a−c)

where: a is the number of set bits in A, b is the number of set bits in B, and c is the number of common set bits in A and B. In this case, b is equal to c. On the other hand, with the threshold set to 100% the Super Node will be at the centroid of all the VMs. In order to further clarify how changing the threshold will affect the clustering output, FIG. 15 will be used as an example setup. FIG. 15 shows an example setup of Application 1 1584, Application 2 1586, and their respective VMs.

In this example there is a constraint [VM1, VM4, VM3]. In this case, if a really low threshold is used, say 0%, then the super node formed will represent all connections of VM3 as well as the VMs of Application 2 and will be nearest to VM3. So, Super Node might become a part of Application 2 after Clustering.

Whereas if a really high constraint is used, say 100%, then the super node formed will be relatively closer to VM2 and will get clustered with VM2 from Application 1 1584 rather than Application 2 1586, which will result in the correct output for this particular case.

In one embodiment a fast embed approach is used for clustering. This approach is based on altering the vector space to ensure all the VMs from same constraint remain in same cluster after clustering. The intuition is that if there are multiple VMs with same vector embedding then they will be clustered into same cluster. In one embodiment, the constraint based fast embed algorithm is a constraint based semi supervised process wherein a set of constraints are used to improve an embedding generation layer before iterative clustering.

In one embodiment, the application constraints are generated using the VIP data available from the load balancer config file. In one embodiment, the port data is ignored. Constraints can be generated based on load balancer config/network device config/user input example csv (as seen in at least FIG. 21).

FIG. 16 shows an example of a table of inputs 1688 and a table of outputs 1699 for a fast embed approach. In this example, the table of inputs 1688 is the data acquired from the load balancer that shows the VMs and their respective VIPs. The table of outputs 1690 is the constraints and the VMs that are tired to the constraints.

In this example, since VM1 and VM2 are being served by same VIP then any VM which is being served by any VIP associated with VM1 and VM2 should be part of the same constraint. With that, VM1, VM2, and VM3 are part of the same constraint, whereas VM4 is part of a separate constraint.

In one embodiment, the intersection of any two constraints shall be NULL. This is because if there exists any common VMs between two constraints then there must be a VIP that must be common for those constraints and therefore they must be merged together.

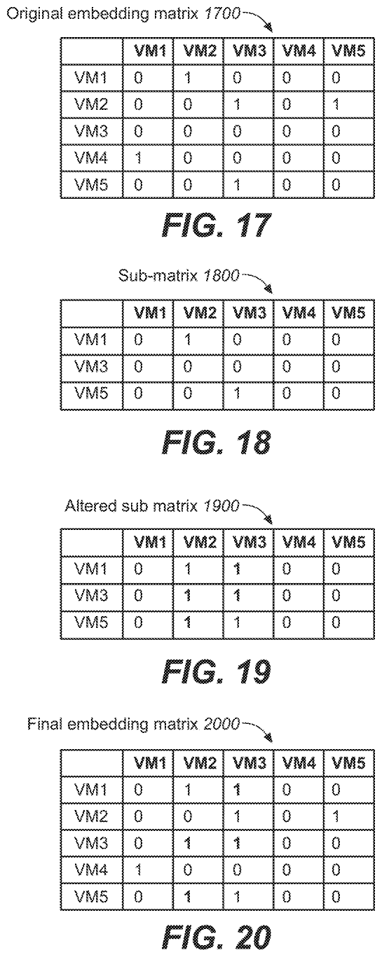

In one embodiment, there is an original embedding matrix where VM1, VM2 . . . VMn are used as the rows and columns. FIG. 17 shows an example table of an original embedding matrix 1700.

In one embodiment, one or more of the VMs in the original embedding matrix are part of the same constraint. In order to change the vector space, a sub-matrix is generated where the columns remain unchanged, but the rows are all VMs that are part of the same constraint. FIG. 18 shows an example table of a sub matrix 1800. In this example, VM1, VM3, and VM5 are part of the same constraint and are therefore used as the rows of sub matrix 1800. In one embodiment, separate sub-matrices are generated for each constraint.

In one embodiment, the columns of the sub-matrix are reviewed, and the highest value is selected. An altered sub-matrix, with the same row and column titles, is then generated. FIG. 19 shows an example of an altered sub matrix 1900.

The altered sub-matrix takes the highest number as previously found for each column and makes the values of each column uniform. Looking at altered sub matrix 1900, it can be seen that the columns for VM2 and VM3 were edited to the highest value, which in this example is 1. By changing this value, the distance between the VMs is decreased, which indicated that they are clustered together.

The altered sub-matrix is then merged with the original embedding matrix to result in the final embedding matrix. FIG. 20 shows an example table of a final embedding matrix 2000. In this example, it can be seen that while values for VM1, VM3, and VM5 were altered, VM2 and VM4 remain unchanged. In one embodiment, other values are separately altered through the use of multiple sub matrices that are merged into a final embedding matrix.

This method ensures that all the VMs that are part of same constraint have same embedding vector space.

In one embodiment, even if a VM is not included in a sub matrix or altered submatrix, it may still become part of the same cluster as those in a sub matrix or altered sub matrix due to similarity with the other VMs. In one embodiment, the embedding is done at each layer of clustering.

In one embodiment, there are tier level constraints that are generated by considering the hosted ports at VIP. In this embodiment, the columns of the tables used in the fast embed approach would instead be the port number instead of the VM. The port number is the port that the VM is accessing.

In one embodiment, a single system is capable of utilizing the constraint based boosting algorithm, the super node approach, and the fast embed approach. In one embodiment, the system uses ML to learn when each of the constraint based semi supervised processes (i.e., constraint based boosting algorithm, constraint based super node algorithm, and the constraint based fast embed algorithm) should be used for the best results based on variables such as precision, accuracy, recall, speed, etc. In one embodiment, all three approaches can be combined.

### CONCLUSION

The examples set forth herein were presented in order to best explain, to describe particular applications, and to thereby enable those skilled in the art to make and use embodiments of the described examples. However, those skilled in the art will recognize that the foregoing description and examples have been presented for the purposes of illustration and example only. The description as set forth is not intended to be exhaustive or to limit the embodiments to the precise form disclosed. Rather, the specific features and acts described above are disclosed as example forms of implementing the Claims.

Reference throughout this document to “one embodiment,” “certain embodiments,” “an embodiment,” “various embodiments,” “some embodiments,” “various embodiments”, or similar term, means that a particular feature, structure, or characteristic described in connection with that embodiment is included in at least one embodiment. Thus, the appearances of such phrases in various places throughout this specification are not necessarily all referring to the same embodiment. Furthermore, the particular features, structures, or characteristics of any embodiment may be combined in any suitable manner with one or more other features, structures, or characteristics of one or more other embodiments without limitation.

What is claimed:

1. A computer-implemented method for automated application discovery in a virtual computing environment, said method comprising:
automatically monitoring communications between a plurality of diverse components in said computing environment;
generating network flow information in relation to said plurality of diverse components in said computing environment;
utilizing said network flow information in a constraint based semi supervised process;
providing a machine learning based discovery of a plurality of applications spanning across said plurality of diverse components in said computing environment; and
creating a software defined network based upon the application boundary endpoints.

2. The computer-implemented method of claim 1, wherein said machine learning based discovery of said plurality of applications, comprises:
associating workload information in said plurality of components with said netflow information of a plurality of components and generating a communication graph of said plurality of applications of said computing network environment.

3. The computer-implemented method of claim 2, wherein said machine learning based discovery of a plurality of applications further comprises:
clustering said plurality of applications accessing common components of said computing network environment.

4. The computer-implemented method of claim 3, wherein said machine learning based discovery of a plurality of applications further comprises:
determining the boundaries of each of said plurality of applications in said computing environment.

5. The computer-implemented method of claim 4, wherein said machine learning based discovery of a plurality of applications further comprises:
segregating the endpoints with said plurality of applications into multiple tiers based on similarity pattern detected of hosted endpoints of said plurality of applications of said computing environment.

6. The computer-implemented method of claim 3, wherein said clustering of said plurality of applications further comprises:
performing a vectorization of said endpoints to create an adjacency matrix of an endpoint communication graph.

7. The computer-implemented method of claim 6, wherein for every N endpoint a N*N adjacency matrix is generated and wherein each row of said matrix corresponds to an endpoint is a vector representation of said endpoint in N-dimensional space.

8. The computer-implemented method of claim 7, wherein said clustering of said plurality of applications further comprises dimensionally reducing the matrix of said plurality of applications using value decomposition to reduce the number of dimensions of said endpoints to be processed.

9. The computer-implemented method of claim 8, wherein said dimensional reduction further comprises generating a cumulative variance ratio as a fraction of the number of dimensions to change the optimal number of dimensions to reduce.

10. The computer-implemented method of claim 6, wherein said endpoints hosting and accessing similar ports of said components are deemed to be part of the same tier.

11. The computer-implemented method of claim 10, further comprising:
associating network identifiers of said features of said components of said computing environment to said communication flow information. The computer-implemented method of claim 1 further comprising:
automatically providing said results for said automated analysis of said features of said components of said computing environment without requiring intervention by a system administrator.

12. The computer-implemented method of claim 1, wherein said constraint based semi supervised process is a constraint based boosting algorithm wherein a set of constraints are used to boost a clustering output in at least one clustering process.

13. The computer-implemented method of claim 1, wherein said constraint based semi supervised process is a constraint based super node algorithm wherein a set of constraints are used to merge a set of nodes before an iterative clustering process.

14. The computer-implemented method of claim 1, wherein said constraint based semi supervised process is a constraint based fast embed algorithm wherein a set of constraints are used to improve an embedding generation layer before iterative clustering.

15. The computer-implemented method of claim 1, wherein said constraint based semi supervised process utilizes a constraint based boosting algorithm wherein a set of constraints are used to boost a clustering output in at least one clustering process, a constraint based fast embed algorithm wherein a set of constraints are used to improve an embedding generation layer before iterative clustering, and a constraint based fast embed algorithm wherein a set of constraints are used to improve an embedding generation layer before iterative clustering, wherein machine learning is used to determine when each approach should be used.

16. The computer-implemented method of claim 1, wherein a constraint processing layer is responsible for generating a set of constraints based on said network flow information.

17. A computer-implemented method for automatically discovering applications in an agentless plurality of diverse components in a computing environment said method comprising:
automatically generating component flow data;
automatically enriching said flow data with workload information pertaining to said plurality of diverse components to generate a connectivity graph wherein said connectivity graph includes one or more weakly connected components;
further using said flow data enriched with workload information pertaining to said plurality of diverse components to run a constraint based semi supervised process;
generating applications spanning across said plurality of diverse components, providing said results for said automated analysis of said features of said components; and
creating a software defined network based upon the application boundary endpoints.

18. The computer-implemented method of claim 17, further comprising:
utilizing machine learning clustering and outlier detection based on statistics measures to detect boundaries of said plurality of applications.

19. The computer-implemented method of claim 18, further comprising
Generating said boundaries with said plurality of applications based on similarities in the pattern of host service endpoints and access service endpoints of said components to generate tiers of said plurality of applications of said computing environment.

20. The computer-implemented method of claim 17, wherein said machine learning cluster and outlier detection further comprises data normalization of to filter out said flow data.

21. The computer-implemented method of claim 20, wherein said machine learning cluster and outlier detection further comprises an application disconnection component for processing said normalized flow data to identify weakly connected components in said computing environment.

22. The computer-implemented method of claim 21, wherein said outlier detection detects said application outliers based on a number of incoming connections and a number of outgoing connections of said workload of said plurality of components in said computing environment.

23. The computer-implemented method of claim 22, wherein said machine learning clustering component comprises taking connected graph components and generating cluster of workloads of said components and wherein each cluster contains workloads of similar pattern.

24. The computer-implemented method of claim 22, wherein said machine learning clustering component creates a adjacency matrix graph of said workloads and wherein said connection matrix in N dimension space with each of said workloads representing said dimension and each row of said matrix representing said point in said N dimension space.

25. The computer-implemented method of claim 17, further comprising:
Tier discovery for creating boundaries within each of said plurality of applications based on similarities in the pattern of hosted service endpoints and accessed service endpoints of said workloads in said components in said computing environment.

26. The computer-implemented method of claim 17, wherein said constraint based semi supervised process is a constraint based boosting algorithm wherein a set of constraints are used to boost a clustering output in at least one clustering process.

27. The computer-implemented method of claim 17, wherein said constraint based semi supervised process is a constraint based super node algorithm wherein a set of constraints are used to merge a set of nodes before an iterative clustering process.

28. The computer-implemented method of claim 17, wherein said constraint based semi supervised process is a constraint based fast embed algorithm wherein a set of constraints are used to improve an embedding generation layer before iterative clustering.

29. The computer-implemented method of claim 17, wherein said constraint based semi supervised process utilizes a constraint based boosting algorithm wherein a set of constraints are used to boost a clustering output in at least one clustering process, a constraint based fast embed algorithm wherein a set of constraints are used to improve an embedding generation layer before iterative clustering, and a constraint based fast embed algorithm wherein a set of constraints are used to improve an embedding generation layer before iterative clustering, wherein machine learning is used to determine when each approach should be used.

30. The computer-implemented method of claim 17, wherein a constraint processing layer is responsible for generating a set of constraints based on said network flow information.
